(19) United States
(12) Patent Application Publication
(10) Pub. No.: US 2025/0148461 A1
(43) Pub. Date: May 8, 2025

(54) ORBITAL DATA STORAGE SYSTEM

(71) Applicant: Manhattan VC Holding LLC, New York, NY (US)

(72) Inventor: Hugo Remi, New York, NY (US)

(21) Appl. No.: 18/937,514

(22) Filed: Nov. 5, 2024

Related U.S. Application Data
(60) Provisional application No. 63/596,325, filed on Nov. 6, 2023.

(51) Int. Cl. G06Q 20/38; G06F 16/27; G06Q 40/04; H04B 7/185

(52) U.S. Cl. CPC G06Q 20/389; G06F 16/27; G06Q 40/04; H04B 7/18519

(57) ABSTRACT

An orbital data storage system including a first computing device located on a planet, a first database located on the planet, and a plurality of satellites orbiting the planet, wherein each satellite of the plurality of satellites including a second computing device, a second database, a battery, and a solar panel, wherein the first computing device and the second computing device are operatively arranged to communicate to store financial data on the first database and the second database.

### CROSS-REFERENCE TO RELATED APPLICATIONS

This application claims the benefit under 35 U.S.C. § 119 (e) of U.S. Provisional Application No. 63/596,325, filed Nov. 6, 2023, which application is incorporated herein by reference in its entirety.

### FIELD

The present disclosure relates to data storage systems, and more particularly, to an orbital data storage system that utilizes satellites to support an ultra-secure wireless financial network.

### BACKGROUND

A financial network is a concept describing any collection of financial entities (such as traders, firms, banks and financial exchanges) and the links between them, ideally through direct transactions or the ability to mediate a transaction. In network science terms, financial networks are composed of financial nodes, where nodes represent financial institutions or participants, and of edges, where edges represent formal or informal relationships between nodes.

The concept and use of financial networks has emerged in response to the observation that modern financial systems exhibit a high degree of interdependence. Globalization has magnified the level of financial interdependence across many kinds of organizations. Shares, assets, and financial relationships are held and engaged in at a greater degree over time. The trend is a topic of major interest in the financial sector, particularly due to its implications on financial crises. Crises such as the crash of Long-Term Capital Management (LTCM) in 1998, the 1997 Asian financial crisis, the 1998 Russian financial crisis, and the 2008 financial crisis have led many economists to adopt the view that the very networked architecture of the financial system plays a central role in shaping systemic risk.

Thus, there is a need for a secure and stable global financial network.

### SUMMARY

The present disclosure is directed to one or more exemplary embodiments of an orbital data storage system.

In an exemplary embodiment, the orbital data storage system comprises a first computing device located on a planet, a first database located on the planet, and a plurality of satellites orbiting the planet, wherein each satellite of the plurality of satellites comprises a second computing device, a second database, a battery, and a solar panel, wherein the first computing device and the second computing device are operatively arranged to communicate to store financial data on the first database and the second database.

In an exemplary embodiment, the solar panel is operatively arranged to power the second computing device and/or the second database. In an exemplary embodiment, the solar panel is operatively arranged to charge the battery, and the battery is operatively arranged to power the second computing device and/or the second database.

In an exemplary embodiment, the orbital data storage system further comprises one or more non-transitory computer readable storage media, and program instructions stored on the at least one non-transitory computer readable storage media, the program instructions comprising program instructions to receive a request to process a financial transaction, program instructions to process the financial transaction, and program instructions to store data related to the financial transaction in the first database and the second database. In an exemplary embodiment, the program instructions further comprise program instructions to verify that data stored in the first database and relating to the financial transaction is identical to data stored in the second database and related to the financial transaction.

In an exemplary embodiment, the program instructions further comprise program instructions to determine that the data stored in the first database and relating to the financial transaction is identical to the data stored in the second database and related to the financial transaction, and program instructions to provide an indication that there is no error related to the financial transaction. In an exemplary embodiment, the program instructions further comprise program instructions to determine that the data stored in the first database and relating to the financial transaction is not identical to the data stored in the second database and related to the financial transaction, and program instructions to provide an indication that there is an error related to the financial transaction.

In an exemplary embodiment, the request to process the financial transaction comprises a request for currency exchange. In an exemplary embodiment, the program instructions further comprise program instructions to retrieve a plurality of exchange rates, wherein each exchange rate of the plurality of exchange rates relates to a different currency, and program instructions to determine a new currency exchange rate. In an exemplary embodiment, the program instructions to determine a new currency exchange rate comprises program instructions to calculate the sum of the exchange rates, and program instructions to divide the sum of the exchange rates by the total number of exchange rates. In an exemplary embodiment, the planet is Earth.

The present disclosure is directed to one or more exemplary embodiments of a method of storing financial transaction data.

In an exemplary embodiment, the method comprises receiving a request to process a financial transaction, processing the financial transaction, and storing data related to the financial transaction in a first database located on a planet and a plurality of second databases, wherein each second database of the plurality of second databases is arranged on a satellite orbiting the planet.

In an exemplary embodiment, the method further comprises verifying that data stored in the first database and relating to the financial transaction is identical to data stored in the second database and related to the financial transaction. In an exemplary embodiment, the method further comprises determining that the data stored in the first database and relating to the financial transaction is identical to the data stored in the second database and related to the financial transaction, and providing an indication that there is no error related to the financial transaction. In an exemplary embodiment, the method further comprises determining that the data stored in the first database and relating to the financial transaction is not identical to the data stored in the second database and related to the financial transaction, and providing an indication that there is an error related to the financial transaction.

In an exemplary embodiment, the request to process the financial transaction comprises a request for currency exchange. In an exemplary embodiment, the method further comprises retrieving a plurality of exchange rates, wherein each exchange rate of the plurality of exchange rates relates to a different currency, and determining a new currency exchange rate. In an exemplary embodiment, the step of determining a new currency exchange rate comprises calculating the sum of the exchange rates, and dividing the sum of the exchange rates by the total number of exchange rates. In an exemplary embodiment, the planet is Earth.

The present disclosure is directed to one or more exemplary embodiments of a computer program product for securely storing financial transaction data.

In an exemplary embodiment, the computer program product comprises a non-transitory computer readable storage medium and program instructions stored on the non-transitory computer readable storage medium, the program instructions comprising program instructions to receive a request to process a financial transaction, program instructions to process the financial transaction, program instructions to store data related to the financial transaction in a first database located on a planet and a plurality of second databases, wherein each second database of the plurality of second databases is arranged on a unique satellite orbiting the planet, and program instructions to verify that data stored in the first database and relating to the financial transaction is identical to data stored in the second database and related to the financial transaction.

These and other objects, features, and advantages of the present disclosure will become readily apparent upon a review of the following detailed description of the disclosure, in view of the drawings and appended claims.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure, in which corresponding reference symbols indicate corresponding parts. However, the drawings do not illustrate all possible implementations of the presently disclosed subject matter and are not intended to limit the scope of the present disclosure in any way.

FIG. 1 is a schematic view of an orbital data storage system environment.

FIG. 2 is a front view of a portion of a display screen with a graphical user interface.

FIG. 3 is a front view of a portion of a display screen with a graphic user interface.

FIG. 4 is a front view of a portion of the display screen shown in FIG. 2 with a graphic user interface.

FIG. 5 is the chart shown in FIG. 3 showing attributes of a satellite.

FIG. 6 is a chart showing currencies and corresponding values.

FIG. 7 is a block diagram of internal and external components of a computing system, in accordance with an exemplary embodiment of the present disclosure.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

Where used herein, the terms “first,” “second,” and so on, do not necessarily denote any ordinal, sequential, or priority relation, but are simply used to more clearly distinguish one element or set of elements from another, unless specified otherwise.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “substantially” is intended to mean values within ten percent of the specified value.

Where used herein, the term “exemplary” is intended to mean “an example of,” “serving as an example,” or “illustrative,” and does not denote any preference or requirement with respect to a disclosed aspect or embodiment.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element. A similar interpretation is intended when the phrase “used in at least one of:” is used herein.

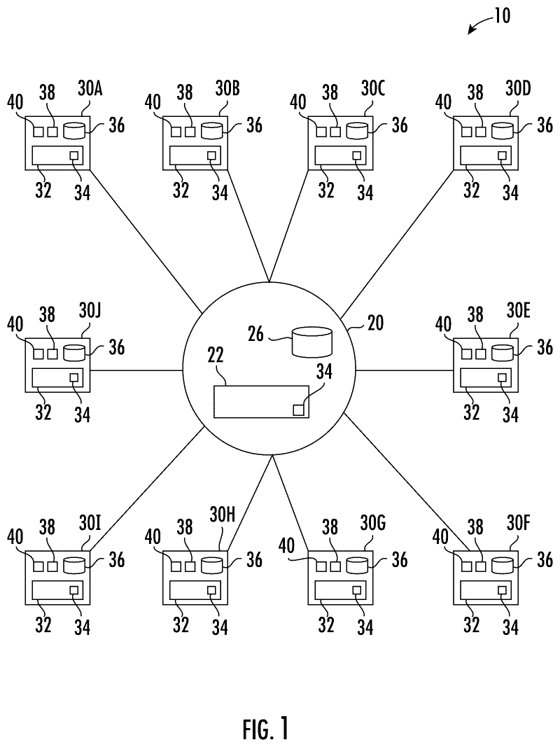

Referring now to the figures, FIG. 1 is a functional block diagram illustrating an orbital data storage system environment, generally designated 100, in accordance with one embodiment of the present disclosure. FIG. 1 provides only an illustration of one implementation, and does not imply any limitations with regard to the environments in which different embodiments may be implemented. Many modifications to the depicted environment may be made by those skilled in the art without departing from the scope of the disclosure as recited by the claims. In an exemplary embodiment, environment 100 includes planet or Earth 20, at least one Earth-based computing device 22, database 26, and at least one satellite 30, for example satellites 30A-30J. In an exemplary embodiment, each of the satellites 30 comprises computing device 32, database 36, at least one battery 38, and at least one solar panel 40. Satellites 30 are capable of communicating with computing device 22, for example, via a transponder (e.g., using radio waves).

Computing device 22 may be a hardware device that allows a user located on Earth 20 to conduct financial transactions and transmits those transactions to one or more satellites 30 for orbital storage via orbital data storage transaction program 34. Computing device 22 is capable of communicating with database 26 and satellites 30. In an exemplary embodiment, computing device 22 may include a computer. In an exemplary embodiment, computing device 22 may include internal and external hardware components, as depicted and described in further detail with respect to FIG. 7. In an exemplary embodiment, orbital data storage transaction program 34 is implemented on a web server, which may be a management server, a web server, or any other electronic device or computing system capable of receiving and sending data. The web server can represent a computing system utilizing clustered computers and components to act as a single pool of seamless resources when accessed through a network. The web server may include internal and external hardware components, as depicted and described in further detail with respect to FIG. 7.

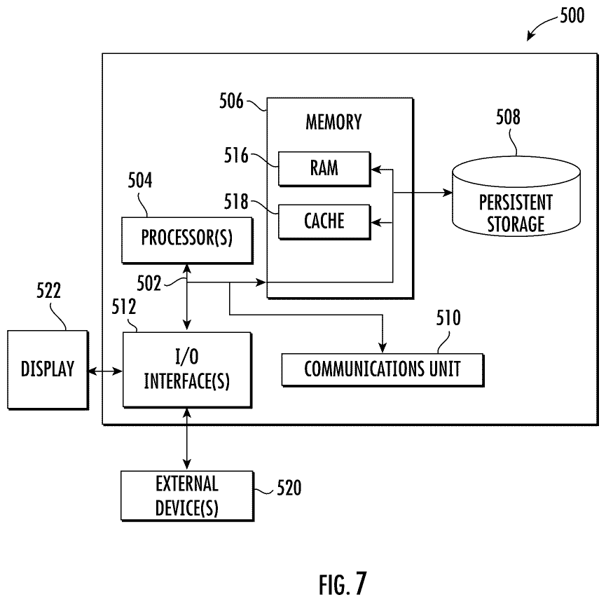

Database 26 is a central storage for financial transaction data. Database 26 can be implemented using any non-volatile storage medium known in the art. For example, authentication database can be implemented with a tape library, optical library, one or more independent hard disk drives, or multiple hard disk drives in a redundant array of independent disks (RAID). In some embodiments, database 26 may contain a set of data related to financial parameters, data related to currency exchange rates (see FIG. 6), and/or trade data, as described in greater detail below.

Satellites 30, 30A-30J orbit Earth 20 and are arranged for the storage of financial transaction data. Each of satellites 30, 30A-30J comprises computing device 32, database 36, one or more batteries 38, and one or more solar panels 40. In an exemplary embodiment, each of satellites 30, 30A-30J comprises a transponder (i.e., transmitter and receiver). Satellites 30 are capable of communicating with Earth 20 as well as each other, for example, using radio wave communication.

Computing device 32 may be a hardware device that allows a user located on Earth 20 to conduct financial transactions and transmits those transactions to one or more satellites 30 for orbital storage via orbital data storage transaction program 34. Computing device 32 is capable of communicating with database 36 and computing device 22. In an exemplary embodiment, computing device 32 may include a computer. In an exemplary embodiment, computing device 32 may include internal and external hardware components, as depicted and described in further detail with respect to FIG. 7.

Database 36 is a central storage for financial transaction data. Database 36 can be implemented using any non-volatile storage medium known in the art. For example, authentication database can be implemented with a tape library, optical library, one or more independent hard disk drives, or multiple hard disk drives in a redundant array of independent disks (RAID). In some embodiments, database 36 may contain a set of data related to financial parameters, data related to currency exchange rates (see FIG. 6), and/or trade data, as described in greater detail below.

Solar panel 40 is operatively arranged to power the electrical components of its respective satellite 30 and/or charge battery 38 to power the electrical components of respective satellite 30. Solar panel 40 receives energy from the sun.

Orbital data storage transaction program 34 can receive requests to perform financial transactions, for example, depositing funds, transferring funds, withdrawing funds, transferring a security (e.g., stock, bond, preferred stock, warrant, purchase contract, right, unit, secured note, etc.), buying a security, selling a security, etc. Orbital data storage transaction program 34 is capable of performing the requested financial transaction and storing data associated therewith in database 36. In an exemplary embodiment, orbital data storage transaction program 34 saves data associated with a financial transaction on every database in environment 10, for example, database 26 and databases 36. As such, multiple copies of the transaction data are saved on many machines/databases, and they must all match for the transaction data to be valid. Orbital data storage transaction program 34 is operatively arranged to create a network that facilitates payments and financial transactions. Orbital data storage transaction program 34 is operatively arranged to process, distribute, and mine payments and accounting units.

In an exemplary embodiment, orbital data storage transaction program 34 is operatively arranged to generate a currency exchange rate, for example for a financial transaction. For example, orbital data storage transaction program 34 generates a currency exchange rate that is equal to the average of the exchange rates of one or more (e.g., ten) world currencies. FIG. 6 shows a chart illustrating ten world currencies, represented by numbers 1-10, and their respective values in rupees and U.S. dollars (USD). In an exemplary embodiment, orbital data storage transaction program 34 obtains the value of each of the top ten world currencies in USD and calculates the exchange rate between 1 United Space Finance (USF) unit and 1 USD. In an exemplary embodiment, orbital data storage transaction program 34 calculates the exchange rate using the following equation:

$${( 1 U S F )}^{1} = \frac{1 + 2 + 3 + 4 + 5 + 6 + 7 + 8 + 9 + 10}{10} = \$1 \text{.688}$$

It should be appreciated that the values shown in FIG. 6 may be adjusted based on the current date and are subject to inflation. As such, in an exemplary embodiment orbital data storage transaction program 34 retrieves such values at the time of the transaction. Thus, a user can exchange USF currency for another world currency using orbital data storage transaction program 34. The process of averaging out world currencies promotes stability and independence from the world economy, and adaptability to any crises or changes.

In an exemplary embodiment, servers arranged on Earth 20 (e.g., in the U.S., Canada, or elsewhere in North America) are utilized to support space infrastructure from Earth. In an exemplary embodiment, orbital data storage transaction program 34 allows users to manage blockchain finance using USF currency or cryptocurrency. In an exemplary embodiment, orbital data storage transaction program 34 connects a plurality of satellites connected in one blockchain to exchange payment information, process financial and fund transactions, and mine new USF currencies or units. In an exemplary embodiment, environment 10 facilitates a system and method to decentralize a payment network, which is based on the network created by satellites 30. In an exemplary embodiment, orbital data storage transaction program 34 may be accessed from anywhere on Earth 20, thereby allowing payments and transactions to occur, for example, out at sea, in the deep ocean, or in the air (e.g., stratosphere).

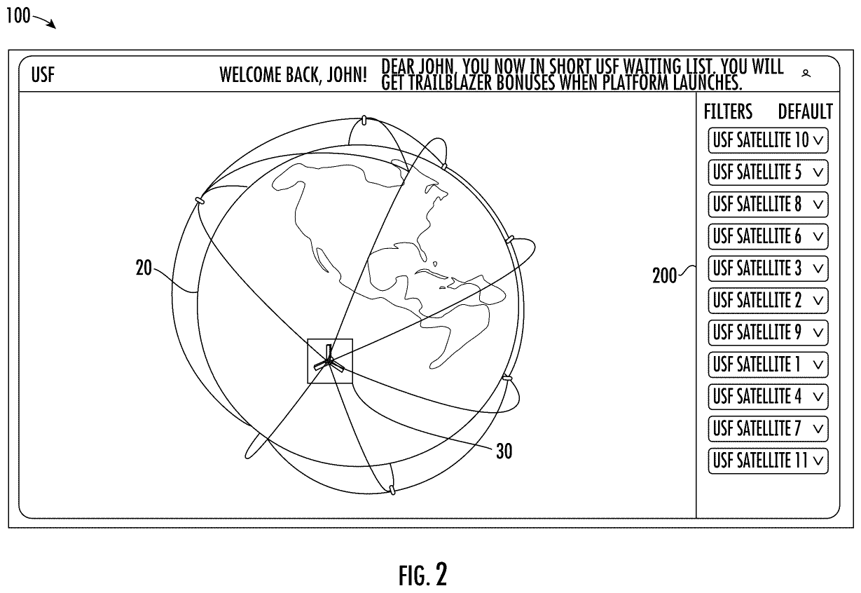

FIG. 2 is a front view of portion 100 of a display screen with a graphical user interface. Portion 100 shows Earth 20 and the arrangement of satellites 30 orbiting thereabout. Satellites 30 are shown communicating with each other and with Earth 20, as explained above with respect to environment 10. In an exemplary embodiment, portion 100 further shows portion 200. A user may select any of satellites 30 and/or elements of portion 200.

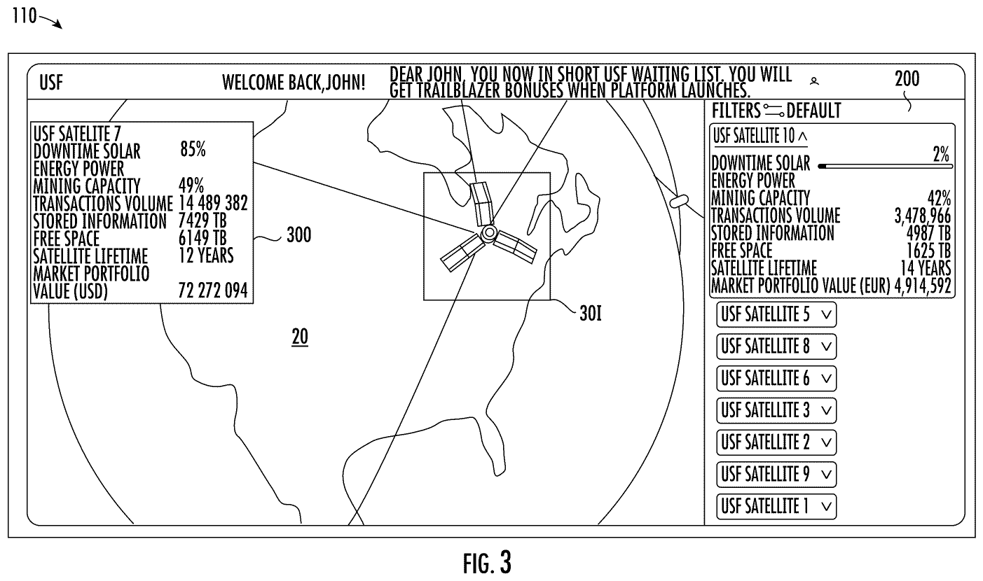

FIG. 3 is a front view of portion 110 of a display screen with a graphic user interface. When a user clicks on a satellite 30, for example in portion 100 shown in FIG. 2, orbital data storage transaction program 34 may then display portion 110. Portion 110 shows Earth 20, satellite 301, portion 200, and chart 300.

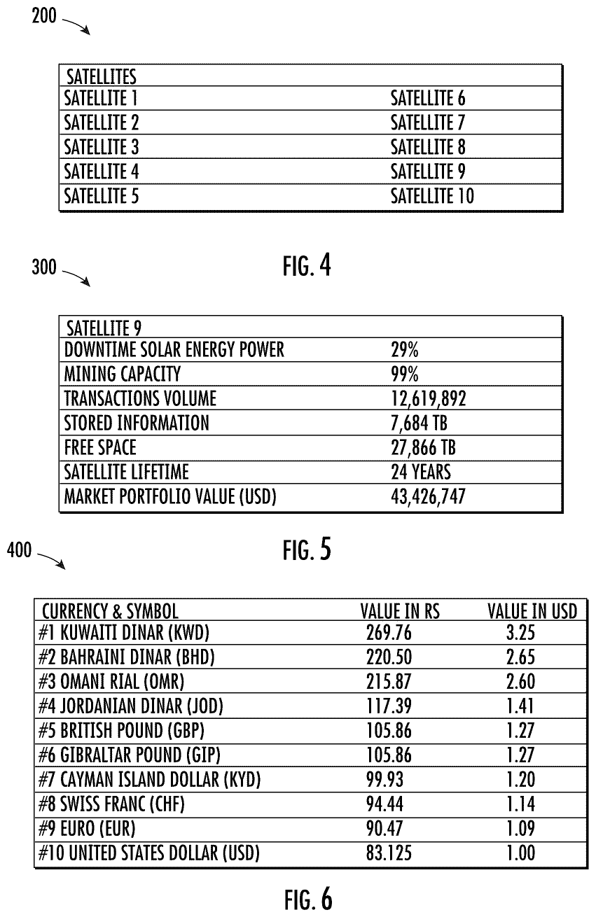

FIG. 4 is a front view of portion 200 of the display screen shown in FIGS. 2 and 3 with a graphic user interface. In an exemplary embodiment, portion 200 is a menu showing all active satellites, for example, satellites 1-10 corresponding to satellites 30A-30J. A user may select any of satellites 1-10 in portion 200 to view additional information about the selected satellite.

FIG. 5 shows chart 300 of FIG. 3 showing attributes of a satellite, for example, satellite 9 corresponding to satellite 301. As shown, chart 300 displays various data regarding the selected satellite. For example, chart 300 shows downtime solar energy power or remaining power in battery 38 (e.g., 29%), mining capacity (e.g., 99%), transactions volume (e.g., 12,619,892), stored information or data (e.g., 7,684 TB), free or available space (e.g., 27,866 TB), satellite lifetime or remaining life (e.g., 24 years), and/or market portfolio value (e.g., 43,426,747 USD).

FIG. 7 is a block diagram of internal and external components of computing system or device 500, which is representative of an example of computing device 22 and computing device 32 shown in FIG. 1, in accordance with an exemplary embodiment of the present disclosure. It should be appreciated that FIG. 7 provides only an illustration of one implementation and does not imply any limitations with regard to the environments in which different embodiments may be implemented. In general, the components illustrated in FIG. 7 are representative of any electronic device capable of executing machine-readable program instructions. Examples of computer systems, environments, and/or configurations that may be represented by the components illustrated in FIG. 7 include, but are not limited to, personal computer systems, server computer systems, thin clients, thick clients, laptop computer systems, tablet computer systems, cellular telephones (i.e., smart phones), multiprocessor systems, microprocessor-based systems, network PCs, minicomputer systems, mainframe computer systems, and distributed cloud computing environments that include any of the above systems or devices.

Computing device 500 includes communications fabric 502, which provides for communications between one or more processing units 504, memory 506, persistent storage 508, communications unit 510, and one or more input/output (I/O) interfaces 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM) 516 and cache memory 518. In general, memory 506 can include any suitable volatile or non-volatile computer readable storage media. Software is stored in persistent storage 508 for execution and/or access by one or more of the respective processors 504 via one or more memories of memory 506.

Persistent storage 508 may include, for example, a plurality of magnetic hard disk drives. Alternatively, or in addition to magnetic hard disk drives, persistent storage 508 can include one or more solid state hard drives, semiconductor storage devices, read-only memories (ROM), erasable programmable read-only memories (EPROM), flash memories, or any other computer readable storage media that is capable of storing program instructions or digital information.

The media used by persistent storage 508 can also be removable. For example, a removable hard drive can be used for persistent storage 508. Other examples include optical and magnetic disks, thumb drives, and smart cards that are inserted into a drive for transfer onto another computer readable storage medium that is also part of persistent storage 508.

Communications unit 510 provides for communications with other computer systems or devices via a network. In this exemplary embodiment, communications unit 510 includes network adapters or interfaces such as a TCP/IP adapter cards, wireless Wi-Fi interface cards, or 3G, 4G, or 5G wireless interface cards or other wired or wireless communications links. The network can comprise, for example, copper wires, optical fibers, wireless transmission, routers, firewalls, switches, gateway computers and/or edge servers. Software and data used to practice embodiments of the present disclosure can be downloaded to computing device 500 through communications unit 510 (i.e., via the Internet, a local area network, or other wide area network). From communications unit 510, the software and data can be loaded onto persistent storage 508.

One or more I/O interfaces 512 allow for input and output of data with other devices that may be connected to computing device 500. For example, I/O interface 512 can provide a connection to one or more external devices 520 such as a keyboard, computer mouse, touch screen, virtual keyboard, touch pad, pointing device, or other human interface devices. External devices 520 can also include portable computer readable storage media such as, for example, thumb drives, portable optical or magnetic disks, and memory cards. I/O interface 512 also connects to display 522.

Display 522 provides a mechanism to display data to a user and can be, for example, a computer monitor. Display 522 can also be an incorporated display and may function as a touch screen, such as a built-in display of a tablet computer.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 Orbital data storage system environment
20 Earth
22 Computing device
26 Database
30 Satellite or satellites
30A Satellite
30B Satellite
30C Satellite
30D Satellite
30E Satellite
30F Satellite
30G Satellite
30H Satellite
30I Satellite
30J Satellite
32 Computing device
34 Orbital data storage transaction program
36 Database
38 Battery
40 Solar panel(s)
100 Portion
110 Portion
200 Portion
300 Chart
400 Chart
500 Computing device
502 Communications fabric
504 Processing units
506 Memory
508 Persistent storage
510 Communications unit
512 Input/output (I/O) interfaces
516 Random access memory (RAM)
518 Cache memory
520 External device(s)
522 Display

What is claimed is:

1. An orbital data storage system, comprising:
a first computing device located on a planet;
a first database located on the planet; and
a plurality of satellites orbiting the planet, wherein each satellite of the plurality of satellites comprises:
a second computing device;
a second database;
a battery; and
a solar panel;
wherein the first computing device and the second computing device are operatively arranged to communicate to store financial data on the first database and the second database.

2. The orbital data storage system as recited in claim 1, wherein the solar panel is operatively arranged to power the second computing device and/or the second database.

3. The orbital data storage system as recited in claim 1, wherein:
the solar panel is operatively arranged to charge the battery; and
the battery is operatively arranged to power the second computing device and/or the second database.

4. The orbital data storage system as recited in claim 1, further comprising:
one or more non-transitory computer readable storage media; and
program instructions stored on the at least one non-transitory computer readable storage media, the program instructions comprising:
program instructions to receive a request to process a financial transaction;
program instructions to process the financial transaction; and
program instructions to store data related to the financial transaction in the first database and the second database.

5. The orbital data storage system as recited in claim 4, wherein the program instructions further comprise:
program instructions to verify that data stored in the first database and relating to the financial transaction is identical to data stored in the second database and related to the financial transaction.

6. The orbital data storage system as recited in claim 4, wherein the program instructions further comprise:
program instructions to determine that the data stored in the first database and relating to the financial transaction is identical to the data stored in the second database and related to the financial transaction; and
program instructions to provide an indication that there is no error related to the financial transaction.

7. The orbital data storage system as recited in claim 4, wherein the program instructions further comprise:
program instructions to determine that the data stored in the first database and relating to the financial transaction is not identical to the data stored in the second database and related to the financial transaction; and
program instructions to provide an indication that there is an error related to the financial transaction.

8. The orbital data storage system as recited in claim 4, wherein the request to process the financial transaction comprises a request for currency exchange.

9. The orbital data storage system as recited in claim 8, wherein the program instructions further comprise:
program instructions to retrieve a plurality of exchange rates, wherein each exchange rate of the plurality of exchange rates relates to a different currency; and
program instructions to determine a new currency exchange rate.

10. The orbital data storage system as recited in claim 9, wherein the program instructions to determine a new currency exchange rate comprises:
program instructions to calculate the sum of the exchange rates; and
program instructions to divide the sum of the exchange rates by the total number of exchange rates.

11. The orbital data storage system as recited in claim 1, wherein the planet is Earth.

12. A method of storing financial transaction data, comprising:
receiving a request to process a financial transaction;
processing the financial transaction; and
storing data related to the financial transaction in a first database located on a planet and a plurality of second databases, wherein each second database of the plurality of second databases is arranged on a satellite orbiting the planet.

13. The method of storing financial transaction data as recited in claim 12, further comprising:
verifying that data stored in the first database and relating to the financial transaction is identical to data stored in the second database and related to the financial transaction.

14. The method of storing financial transaction data as recited in claim 12, further comprising:
determining that the data stored in the first database and relating to the financial transaction is identical to the data stored in the second database and related to the financial transaction; and
providing an indication that there is no error related to the financial transaction.

15. The method of storing financial transaction data as recited in claim 12, further comprising:
determining that the data stored in the first database and relating to the financial transaction is not identical to the data stored in the second database and related to the financial transaction; and
providing an indication that there is an error related to the financial transaction.

16. The method of storing financial transaction data as recited in claim 12, wherein the request to process the financial transaction comprises a request for currency exchange.

17. The method of storing financial transaction data as recited in claim 16, further comprising:
retrieving a plurality of exchange rates, wherein each exchange rate of the plurality of exchange rates relates to a different currency; and
determining a new currency exchange rate.

18. The method of storing financial transaction data as recited in claim 17, wherein the step of determining a new currency exchange rate comprises:
calculating the sum of the exchange rates; and
dividing the sum of the exchange rates by the total number of exchange rates.

19. The method of storing financial transaction data as recited in claim 12, wherein the planet is Earth.

20. A computer program product for securely storing financial transaction data, comprising:
a non-transitory computer readable storage medium and program instructions stored on the non-transitory computer readable storage medium, the program instructions comprising:
program instructions to receive a request to process a financial transaction;
program instructions to process the financial transaction;
program instructions to store data related to the financial transaction in a first database located on a planet and a plurality of second databases, wherein each second database of the plurality of second databases is arranged on a unique satellite orbiting the planet; and
program instructions to verify that data stored in the first database and relating to the financial transaction is identical to data stored in the second database and related to the financial transaction.
